(19) United States
(12) Patent Application Publication
(10) Pub. No.: US 2016/0122475 A1
(43) Pub. Date: May 5, 2016

(54) COPOLYESTERIMIDES DERIVED FROM N,N'-BIS-(HYDROXYALKYL)-PYROMELLITIC DIIMIDE AND FILMS MADE THEREFROM

(71) Applicants: STEPHEN WILLIAM SANKEY, REDCAR (GB); DAVID TURNER, REDCAR (GB); HOWARD COLQUHOUN, READING (GB); STEPHEN MEEHAN, READING (GB)

(72) Inventors: STEPHEN WILLIAM SANKEY, REDCAR (GB); DAVID TURNER, REDCAR (GB); HOWARD COLQUHOUN, READING (GB); STEPHEN MEEHAN, READING (GB)

(73) Assignee: DuPont Teijin Films U.S. Limited Partnership, CHESTER, VA (US)

(21) Appl. No.: 14/896,039

(22) PCT Filed: Jun. 5, 2014
(86) PCT No.: PCT/GB2014/051740

§ 371 Date: Dec. 4, 2015

(30) Foreign Application Priority Data
Jun. 7, 2013 (GB) 1310147.2

(51) Int. Cl. C08G 73/16; C08J 5/18

(52) U.S. Cl. CPC C08G 73/16; C08J 5/18; C08J 2379/08

(57) ABSTRACT

A polyester film comprising a copolyester which comprises repeating units derived from an aliphatic glycol, an aromatic dicarboxylic acid, and the monomer of formula (I): wherein n=2, 3 or 4, and wherein comonomer (I) constitutes a proportion of the glycol fraction of the copolyester.

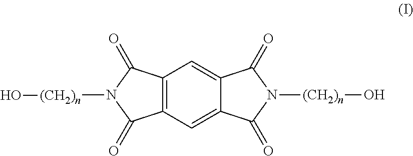

The present invention is concerned with polyesterimides and films made therefrom, and methods for their synthesis. In particular, the present invention is concerned with copolymers of aromatic carboxylic acids, particularly copolymers of poly(alkylene naphthalate)s and copolymers of poly(alkylene terephthalates), which exhibit improved heat-resistance and thermo-mechanical stability.

The glass transition temperature (T_{g}), crystalline melting point (Tₘ) and degree of crystallinity are key parameters in determining the thermo-mechanical properties of polyesters. Previous studies have succeeded in increasing the T_{g} of thermoplastic polymers, primarily homopolymers, but this has typically been accompanied by a corresponding increase in the Tₘ. Such increases in Tₘ can be disadvantageous because a thermoplastic polymer should also remain melt-processible (for instance in an extruder), and should preferably remain so under economic conditions (for instance, below about 320° C., preferably below about 300° C., which allows the use of conventional extrusion equipment). At higher processing temperatures, polymer extrusion requires expensive specialist equipment and a great deal of energy, and typically also results in degradation products. The melt-processing temperature should be well below (for instance, at least about 20° C. below) the decomposition temperature of the polymer. In some cases, comonomers have been introduced into polymers in order to increase T_{g} while retaining Tₘ, but also resulting in convergence of the decomposition temperature and the Tₘ, which leads to the production of degradation products in the melt.

Many attempts have also been made to enhance the glass transition temperature of polyesters by the introduction of more rigid comonomers. However, such comonomers also disrupt the packing of the polymer chains in the crystal lattice, so that while the T_{g} increases, the Tₘ and degree of crystallinity typically both decrease as the proportion of comonomer increases, leading ultimately to amorphous materials. In order to fabricate articles from polymeric materials, it is often critical that the polymer exhibit crystallinity to achieve articles with acceptable thermo-mechanical properties.

Poly(ethylene terephthalate) (PET) is a semi-crystalline copolymer having a glass transition temperature (T_{g}) of 78° C. and a crystalline melting point of (Tₘ) of 260° C. Poly(ethylene naphthalate) (PEN) is a semi-crystalline copolymer having a higher glass transition temperature (T_{g}=120° C.) relative to PET, although their crystalline melting points do not differ greatly (Tₘ=268° C. for PEN). The thermo-mechanical stability of PEN is significantly greater than that of PET. Many of the attempts made to enhance T_{g} by the introduction of more rigid comonomers have focussed on PET, which is significantly cheaper than PEN. There are no commercially available semi-crystalline polyesters with a T_{g} higher than PEN. Polyether ether ketone (PEEK) is one of the few examples of a high T_{g} (approximately 143-146° C.) semi-crystalline thermoplastic polymer, and has been used successfully in engineering and biomedical applications. However, PEEK is suitable only for certain types of articles; for instance, it is not suitable for the manufacture of biaxially oriented films. PEEK is also very expensive and has a high crystalline melting point (approximately 350° C.).

The underlying objective of the present invention is the provision of copolyester films made from a copolyester having a T_{g} which is higher than the corresponding base polyester, without significantly increasing the Tₘ to a point where the polymer is no longer melt-processible under economic conditions, particularly without significantly decreasing the degree of crystallinity of the film (in order to achieve acceptable thermo-mechanical properties), and preferably also without significantly decreasing decomposition temperature.

Thus, an object of the present invention is to provide polyesters which exhibit improved heat-resistance and thermo-mechanical stability. A further object of the present invention is to provide a thermoplastic polymer with high or increased T_{g} but without increasing Tₘ to a point where the polymer is no longer melt-processible under economic conditions (i.e. the polymer should remain melt-processible below about 320° C., preferably below about 300° C.). A further object of the present invention is to provide semi-crystalline polyesters which exhibit high T_{g} as well as high Tₘ. A further object of the present invention is to increase the T_{g} of a polyester without significantly decreasing its Tₘ and/or its degree of crystallinity, and preferably without significantly decreasing its decomposition temperature.

As used herein, the term “without significantly decreasing the Tₘ” means that the Tₘ decreases by no more than 10%, preferably no more than 5%.

As used herein, the term “without significantly decreasing the degree of crystallinity”, means that the polyester retains a degree of crystallinity which is commercially useful, preferably in the range of from about 10% to about 60%, preferably from about 20 to about 50%.

A further object of the present invention is to provide a copolyester having a T_{g} which is higher than the corresponding base polyester, without significantly decreasing its Tₘ and/or its degree of crystallinity and preferably without significantly decreasing its decomposition temperature.

A further object of the present invention is to provide the use of a comonomer suitable for partial substitution of a monomer in a conventional polyester which increases the T_{g} of said polyester without significantly decreasing its Tₘ and/or its degree of crystallinity, and preferably without significantly decreasing its decomposition temperature.

While the objects of the invention do not exclude an increase in Tₘ, any increase in Tₘ must not be so large that melt-processing becomes uneconomical and that the Tₘ and decomposition temperature converge.

As used herein, the term “copolyester” refers to a polymer which comprises ester linkages and which is derived from three or more types of comonomers. As used herein, the term “corresponding base polyester” refers to a polymer which comprises ester linkages and which is derived from two types of comonomers comprising ester-forming functionalities, and which serves as a comparator for a copolyester which is derived from comonomers comprising the comonomers of the corresponding base polyester. A comonomer comprising ester-forming functionalities preferably possesses two ester-forming functionalities.

As used herein, the term “semi-crystalline” is intended to mean a degree of crystallinity of at least about 5% measured according to the test described herein, preferably at least about 10%, preferably at least about 15%, and preferably at least about 20%.

Accordingly, the present invention provides a film comprising a copolyester which comprises repeating units derived from an aliphatic glycol, an aromatic dicarboxylic acid (preferably selected from terephthalic acid and naphthalene-dicarboxylic acid), and the monomer of formula (I):

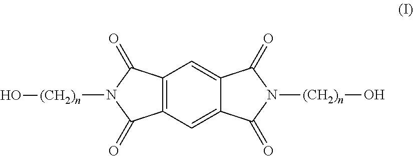

wherein n=2, 3 or 4, and preferably wherein n=2. The monomer of formula (I) is referred to herein as N,N′-bis-(hydroxyalkyl)-pyromellitic diimide (PDI). Where n=2, the monomer is referred to as N,N′-bis-(2-hydroxyethyl)-pyromellitic diimide.

Surprisingly, the present inventors have now found that incorporation of the specific co-monomer (I) into the polyester not only increases the T_{g} substantially but does so without significant detriment to the crystallinity of films made therefrom. This is achieved without significantly increasing the Tₘ. The copolyesters described herein are thermoplastic. Copolyesters and films made therefrom as described herein exhibit semi-crystalline properties. The copolyesters described herein can be readily obtained at high molecular weight. The copolyesters described herein can be melt-processed below 320° C. (preferably below 300° C.) into tough, high strength films. The copolyesters are also referred to herein as co(polyester-imide)s.

The comonomer (I) constitutes a proportion of the glycol fraction of the copolyester. In a preferred embodiment, the comonomer (I) is present in amounts of no more than about 50 mol % of the glycol fraction of the copolyester, preferably no more than about 40 mol %, preferably no more than about 30 mol %, preferably no more than about 20 mol %, preferably no more than about 15 mol %. Preferably the comonomer is present in an amount of at least about 1 mol %, more preferably at least about 3 mol %, more preferably at least about 4 mol % of the glycol fraction of the copolyester.

Where the aromatic acid is naphthalene-dicarboxylic acid, the comonomer (I) is preferably present in amounts of no more than about 15 mol %, preferably no more than about 10 mol %, preferably less than 10 mol %, preferably no more than about 9 mol %, and in one embodiment no more than about 8 mol %.

The inventors have observed that even at low molar fractions of the comonomer (I), small but valuable increases in T_{g} are observed. For instance, a copolyester comprising only 5 mol % comonomer (I) where n=2 exhibits a significant rise in T_{g}, while retaining a good degree of crystallinity.

The aromatic dicarboxylic acid is preferably selected from terephthalic acid and naphthalene-dicarboxylic acid. Other aromatic dicarboxylic acids which may be used in the present invention include isophthalic acid and phthalic acid. The naphthalene-dicarboxylic acid can be selected from 2,5-, 2,6- or 2,7-naphthalene dicarboxylic acid, and is preferably 2,6-naphthalene dicarboxylic acid.

The aliphatic glycol is preferably selected from C₂, C₃ or C₄ aliphatic diols, more preferably from ethylene glycol, 1,3-propanediol and 1,4-butanediol, more preferably from ethylene glycol and 1,4-butanediol, and is most preferably ethylene glycol. The number of carbon atoms in the aliphatic glycol may be the same or different as the number (n) in the comonomer (I), but it is most preferably the same in order to retain crystallinity, particularly in order to retain crystallinity with increasing amounts of comonomer. Thus, the aliphatic glycol preferably has the formula HO(CH₂)ₘOH, where m=n.

In one embodiment, the aliphatic glycol is 1,4-butanediol and n=4. In a preferred embodiment, the aliphatic glycol is ethylene glycol and n=2.

Copolyesters wherein the acid component is selected from 2,6-naphthalene dicarboxylic acid can be described by formula (IIa) below:

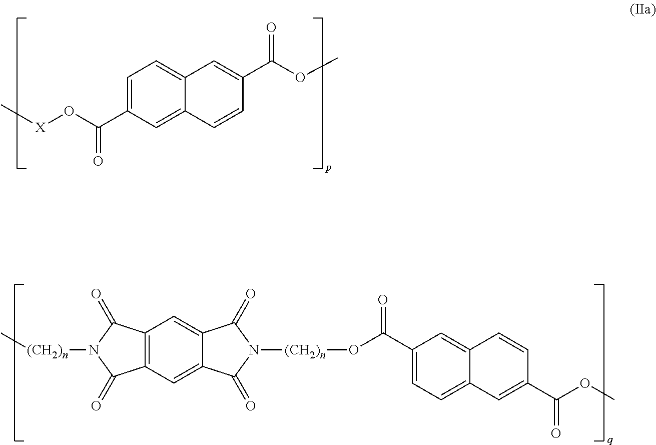

wherein:
n is as defined for formula (I);
the group X is the carbon chain of said aliphatic glycol;
and p and q are the molar fractions of the aliphatic glycol-containing repeating ester units and the monomer (I)-containing repeating ester units, respectively, as defined hereinabove (i.e. q is preferably no more than 50, and p=100-q).

Copolyesters wherein the acid component is selected from terephthalic acid can be described by formula (IIb) below:

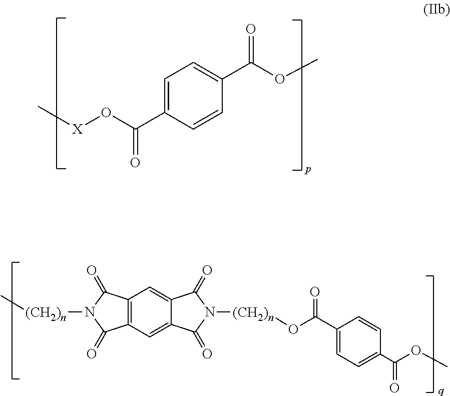

wherein n, X, p and q are as described above.

The copolyester may contain more than one type of the aforementioned aliphatic glycols, and/or more than one type of monomer of formula (I) (i.e. a plurality of types of monomer with differing values of n). Preferably, however, the copolyester comprises a single type of the aforementioned aliphatic glycols. Preferably, the copolyester comprises a single type of monomer of formula (I). Preferably, the copolyester comprises a single type of the aforementioned aliphatic glycols, and a single type of monomer of formula (I). Where the copolyester contains more than one type of said aliphatic glycols, then preferably the copolyester comprises a major aliphatic glycol fraction of a single type of said aliphatic glycols, and a minor aliphatic glycol fraction of one or more different type(s) of said aliphatic glycols, wherein said one or more different type(s) of said aliphatic glycols constitutes no more than 10 mol %, preferably no more than 5 mol %, preferably no more than 1 mol % of the total glycol fraction. Similarly, where the copolyester contains more than one type of said monomer of formula (I), then preferably the copolyester comprises a major fraction of a single type of said monomer of formula (I), and a minor fraction of one or more different type(s) of said monomer of formula (I), wherein said minor fraction of one or more different type(s) of monomer of formula (I) constitutes no more than 10 mol %, preferably no more than 5 mol %, preferably no more than 1 mol % of the total monomer (I) fraction. The copolyesters may contain minor amounts of other glycols and in a preferred embodiment such other glycols constitute no more than 10 mol %, preferably no more than 5 mol %, preferably no more than 1 mol % of the total glycol fraction, but in order to maximise performance it is preferred that the glycol fraction consists of comonomer (I) and said aliphatic glycol(s) described above.

The copolyesters described herein may contain more than one type of carboxylic acid. In this embodiment, the copolyester comprises a first aromatic dicarboxylic acid, which is preferably terephthalic acid or naphthalene-dicarboxylic acid, as described hereinabove, and one or more additional carboxylic acid(s). The additional carboxylic acid(s) is/are present in minor amounts (preferably no more than 10 mol %, preferably no more than 5 mol %, preferably no more than 1 mol % of the total acid fraction) and is/are different to said first aromatic carboxylic acid. The additional carboxylic acid(s) is/are preferably selected from dicarboxylic acids, preferably from aromatic dicarboxylic acids, for instance including terephthalic acid (where the first aromatic dicarboxylic acid is naphthalene-dicarboxylic acid), naphthalene-dicarboxylic acid (where the first aromatic dicarboxylic acid is terephthalic acid), isophthalic acid, 1,4-naphthalenedicarboxylic acid and 4,4′-diphenyldicarboxylic acid. In this embodiment, the first aromatic dicarboxylic acid may be one isomer of naphthalene-dicarboxylic acid, and the additional dicarboxylic acid(s) may be selected from other isomer(s) of naphthalene-dicarboxylic acid.

Preferably, however, the acid fraction consists of a single aromatic dicarboxylic acid as described hereinabove.

Thus, the copolyester described herein preferably contains only aliphatic glycol, an aromatic dicarboxylic acid (preferably terephthalic acid or naphthalene-dicarboxylic acid) and the monomer of formula (I) defined hereinabove.

The copolyesters described herein can be synthesised according to conventional techniques for the manufacture of polyester materials by condensation or ester interchange, typically at temperatures up to about 310° C. Polycondensation may include a solid phase polymerisation (SSP) stage. The solid phase polymerisation may be carried out in a fluidised bed, e.g. fluidised with nitrogen, or in a vacuum fluidised bed, using a rotary vacuum drier. Suitable solid phase polymerisation techniques are disclosed in, for example, EP-A-0419400 the disclosure of which is incorporated herein by reference. Thus, SSP is typically conducted at a temperature 10-50° C. below the crystalline melting point (Tₘ) of the polymer but higher than the glass transition temperature (T_{g}). An inert atmosphere of dry nitrogen or a vacuum is used to prevent degradation. In one embodiment, the copolyester is prepared using germanium-based catalysts which provide a polymeric material having a reduced level of contaminants such as catalyst residues, undesirable inorganic deposits and other by-products of polymer manufacture. Thus, according to a further aspect of the invention, there is provided a process for preparing a copolyester as defined herein, wherein said process comprises the steps of:
(i) reacting said aliphatic glycol with said aromatic dicarboxylic acid to form a bis(hydroxyalkyl)-ester of said aromatic dicarboxylic acid; and
(ii) reacting said bis(hydroxyalkyl)-ester of said aromatic dicarboxylic acid with the monomer (I) under conditions of elevated temperature and pressure in the presence of a catalyst.

In one embodiment, the aliphatic glycol is reacted with the naphthalene dicarboxylic acid to form a bis(hydroxyalkyl)-naphthalate, which is then reacted with the monomer (I) in the desired molar ratios under conditions of elevated temperature and pressure in the presence of a catalyst, as exemplified in Scheme (1) hereinbelow. In a further embodiment, the aliphatic glycol is reacted with the terephthalic acid to form a bis(hydroxyalkyl)-terephthalate, which is then reacted with the monomer (I) in the desired molar ratios under conditions of elevated temperature and pressure in the presence of a catalyst, as exemplified in Scheme (2) hereinbelow.

The process of the invention described hereinabove for preparing copolyesters advantageously allows preparation of the copolyester described herein, and with high selectivity and high yield. The process advantageously also provides a stable and relatively rapid reaction, facilitating a reliable and reproducible polymerisation and allowing scale-up in a safe and economical manner, and also improves the uniformity of the product.

Surprisingly, the copolyesters exhibit an exceptionally low number of carboxyl end-groups, preferably no more than 25, preferably no more than 20, preferably no more than 15, preferably no more than 10, preferably no more than 5, and preferably no more than 1 gram equivalents/10⁶ g polymer, and hence exhibit excellent hydrolytic stability.

According to a further aspect of the present invention, there is provided a copolyester comprising repeating units derived from an aliphatic glycol, an aromatic dicarboxylic acid, and the monomer of formula (I):

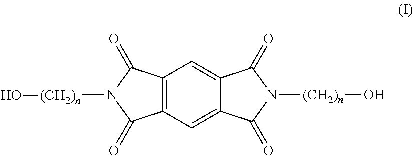

wherein n=2, 3 or 4;
wherein comonomer (I) constitutes a proportion of the glycol fraction of the copolyester; and
wherein said copolyester is obtainable by the process described herein and/or exhibits a carboxyl end-group content of no more than 25, preferably no more than 20, preferably no more than 15, preferably no more than 10, preferably no more than 5, and preferably no more than 1 gram equivalents/10⁶ g polymer.

The copolyesters described herein are particularly suitable for use in applications involving exposure to high temperatures and applications which demand high thermo-mechanical performance. One advantage of the copolyesters described herein over PEEK is that they exhibit T_{g} values approaching those of PEEK, but with a Tₘ which is significantly lower.

Surprisingly, the present inventors have found that incorporation of the specific co-monomer (I) into an aromatic polyester (preferably a terephthalate or naphthalate polyester) not only increases the T_{g} substantially but does so without significant detriment to the crystallinity of films made therefrom. This is achieved without significantly increasing the Tₘ. Films made from the copolyesters described herein exhibit unexpectedly excellent semi-crystalline properties. Semi-crystalline films of the invention exhibit a degree of crystallinity of at least about 5%, preferably at least about 10%, preferably at least about 15%, preferably at least about 20%, and preferably at least about 25%, measured according to the density method described herein. Thus, the present invention provides films wherein the aromatic dicarboxylic acid (or the first dicarboxylic acid as defined herein) is naphthalene dicarboxylic acid and the degree of crystallinity of the film is at least about 5% (preferably 10%, preferably 15%, preferably 20%, preferably 25%) as calculated from the film density and on the basis of the density of 0% crystalline polyethylene naphthalate (PEN) being 1.325 g/cm³ and the density of 100% crystalline PEN being 1.407 g/cm³; and further provides films wherein the aromatic dicarboxylic acid (or the first dicarboxylic acid as defined herein) is terephthalic acid and the degree of crystallinity of the film is at least about 5% (preferably 10%, preferably 15%, preferably 20%, preferably 25%) as calculated from the film density and on the basis of the density of 0% crystalline polyethylene terephthalate (PET) being 1.335 g/cm³ and the density of 100% crystalline PET being 1.455 g/cm³.

The film of the present invention is preferably an oriented film, preferably a biaxially oriented film. Biaxially oriented films in particular are useful as base films for magnetic recording media, particularly magnetic recording media required to exhibit reduced track deviation in order to permit narrow but stable track pitch and allow recording of higher density or capacity of information, for instance magnetic recording media suitable as server back-up/data storage, such as the LTO (Linear Tape Open) format. The film (preferably biaxially oriented film) of the present invention is also particularly suitable for use in electronic and opto-electronic devices (particularly wherein the film is required to be flexible) where thermo-mechanically stable backplanes are critical during fabrication of the finished product, for instance in the manufacture of electroluminescent (EL) display devices (particularly organic light emitting display (OLED) devices), electrophoretic displays (e-paper), photovoltaic (PV) cells and semiconductor devices (such as organic field effect transistors, thin film transistors and integrated circuits generally), particularly flexible such devices.

The copolyester comprising repeating units derived from an aliphatic glycol, an aromatic dicarboxylic acid, and the monomer of formula (I) defined hereinabove is preferably the major component of the film, and makes up at least 50%, preferably at least 65%, preferably at least 80%, preferably at least 90%, and preferably at least 95% by weight of the total weight of the film. Said copolyester is suitably the only polyester used in the film.

Formation of the film may be effected by conventional extrusion techniques well-known in the art. In general terms the process comprises the steps of extruding a layer of molten polymer at a temperature within an appropriate temperature range, for instance in a range of from about 280 to about 300° C., quenching the extrudate and orienting the quenched extrudate. Orientation may be effected by any process known in the art for producing an oriented film, for example a tubular or flat film process. Biaxial orientation is effected by drawing in two mutually perpendicular directions in the plane of the film to achieve a satisfactory combination of mechanical and physical properties. In a tubular process, simultaneous biaxial orientation may be effected by extruding a thermoplastics polyester tube which is subsequently quenched, reheated and then expanded by internal gas pressure to induce transverse orientation, and withdrawn at a rate which will induce longitudinal orientation. In the preferred flat film process, the film-forming polyester is extruded through a slot die and rapidly quenched upon a chilled casting drum to ensure that the polyester is quenched to the amorphous state. Orientation is then effected by stretching the quenched extrudate in at least one direction at a temperature above the glass transition temperature of the polyester. Sequential orientation may be effected by stretching a flat, quenched extrudate firstly in one direction, usually the longitudinal direction, i.e. the forward direction through the film stretching machine, and then in the transverse direction. Forward stretching of the extrudate is conveniently effected over a set of rotating rolls or between two pairs of nip rolls, transverse stretching then being effected in a stenter apparatus. Stretching is generally effected so that the dimension of the oriented film is from 2 to 5, more preferably 2.5 to 4.5 times its original dimension in the or each direction of stretching. Typically, stretching is effected at temperatures higher than the T_{g} of the polyester, preferably about 15° C. higher than the T_{g}. Greater draw ratios (for example, up to about 8 times) may be used if orientation in only one direction is required. It is not necessary to stretch equally in the machine and transverse directions although this is preferred if balanced properties are desired.

A stretched film may be, and preferably is, dimensionally stabilised by heat-setting under dimensional support at a temperature above the glass transition temperature of the polyester but below the melting temperature thereof, to induce the desired crystallisation of the polyester. During the heat-setting, a small amount of dimensional relaxation may be performed in the transverse direction (TD) by a procedure known as “toe-in”. Toe-in can involve dimensional shrinkage of the order 2 to 4% but an analogous dimensional relaxation in the process or machine direction (MD) is difficult to achieve since low line tensions are required and film control and winding becomes problematic. The actual heat-set temperature and time will vary depending on the composition of the film and its desired final thermal shrinkage but should not be selected so as to substantially degrade the toughness properties of the film such as tear resistance. Within these constraints, a heat set temperature of about 150 to 245° C. (typically at least 180° C.) is generally desirable. After heat-setting the film is typically quenched rapidly in order induce the desired crystallinity of the polyester.

In one embodiment, the film may be further stabilized through use of an in-line relaxation stage. Alternatively the relaxation treatment can be performed off-line. In this additional step, the film is heated at a temperature lower than that of the heat-setting stage, and with a much reduced MD and TD tension. The tension experienced by the film is a low tension and typically less than 5 kg/m, preferably less than 3.5 kg/m, more preferably in the range of from 1 to about 2.5 kg/m, and typically in the range of 1.5 to 2 kg/m of film width. For a relaxation process which controls the film speed, the reduction in film speed (and therefore the strain relaxation) is typically in the range 0 to 2.5%, preferably 0.5 to 2.0%. There is no increase in the transverse dimension of the film during the heat-stabilisation step. The temperature to be used for the heat stabilisation step can vary depending on the desired combination of properties from the final film, with a higher temperature giving better, i.e. lower, residual shrinkage properties. A temperature of 135 to 250° C. is generally desirable, preferably 150 to 230° C., more preferably 170 to 200° C. The duration of heating will depend on the temperature used but is typically in the range of 10 to 40 seconds, with a duration of 20 to 30 seconds being preferred. This heat stabilisation process can be carried out by a variety of methods, including flat and vertical configurations and either “off-line” as a separate process step or “in-line” as a continuation of the film manufacturing process. Film thus processed will exhibit a smaller thermal shrinkage than that produced in the absence of such post heat-setting relaxation.

The film may further comprise any other additive conventionally employed in the manufacture of polyester films. Thus, agents such as anti-oxidants, UV-absorbers, hydrolysis stabilisers, cross-linking agents, dyes, fillers, pigments, voiding agents, lubricants, radical scavengers, thermal stabilisers, flame retardants and inhibitors, anti-blocking agents, surface active agents, slip aids, gloss improvers, prodegradents, viscosity modifiers and dispersion stabilisers may be incorporated as appropriate. Such components may be introduced into the polymer in a conventional manner. For example, by mixing with the monomeric reactants from which the film-forming polymer is derived, or the components may be mixed with the polymer by tumble or dry blending or by compounding in an extruder, followed by cooling and, usually, comminution into granules or chips. Masterbatching technology may also be employed. The film may, in particular, comprise a particulate filler which can improve handling and windability during manufacture, and can be used to modulate optical properties. The particulate filler may, for example, be a particulate inorganic filler (e.g. metal or metalloid oxides, such as alumina, titania, talc and silica (especially precipitated or diatomaceous silica and silica gels), calcined china clay and alkaline metal salts, such as the carbonates and sulphates of calcium and barium).

The thickness of the film can be in the range of from about 1 to about 500 μm, typically no more than about 250 μm, and typically no more than about 150 μm. Particularly where the film of the present invention is for use in magnetic recording media, the thickness of the multilayer film is suitably in the range of from about 1 to about 10 μm, more preferably from about 2 to about 10 μm, more preferably from about 2 to about 7 μm, more preferably from about 3 to about 7 μm, and in one embodiment from about 4 to about 6 μm. Where the film is to be used as a layer in electronic and display devices as described herein, the thickness of the multilayer film is typically in the range of from about 5 to about 350 μm, preferably no more than about 250 μm, and in one embodiment no more than about 100 μm, and in a further embodiment no more than about 50 μm, and typically at least 12 μm, more typically at least about 20 μm.

According to a further aspect of the invention, there is provided an electronic or opto-electronic device comprising the film (particularly the biaxially oriented film) described herein, particularly electronic or opto-electronic devices such as electroluminescent (EL) display devices (particularly organic light emitting display (OLED) devices), electrophoretic displays (e-paper), photovoltaic (PV) cells and semiconductor devices (such as organic field effect transistors, thin film transistors and integrated circuits generally), particularly flexible such devices.

According to a further aspect of the invention, there is provided a magnetic recording medium comprising the film (particularly the biaxially oriented film) described herein as a base film and further comprising a magnetic layer on one surface thereof. The magnetic recording medium includes, for example, linear track system data storage tapes such as QIC or DLT, and, SDLT or LTO of a further higher capacity type. The dimensional change of the base film due to the temperature/humidity change is small, and so a magnetic recording medium suitable to high density and high capacity causing less track deviation can be provided even when the track pitch is narrowed in order to ensure the high capacity of the tape.

The following test methods were used to characterise the properties of the novel compounds disclosed herein.
(i) Glass transition temperature (T_{g}); temperature of cold crystallisation (T_{cc}), crystalline melting point (Tₘ) and degree of crystallinity (X_{c}) were measured by differential scanning calorimetry (DSC) using a Universal V4.5A machine (TA Instruments). Unless otherwise stated, measurements were made according to the following standard test method and based on the method described in ASTM E1356-98. The sample was maintained under an atmosphere of dry nitrogen for the duration of the scan (approx. 1.5 to 3 hours). The sample (4-6 mg) was heated from 20° C. to 300° C. at a rate of 20° C./min, held at 300° C. for 5 minutes, and then cooled to 20° C. at a rate of 20° C./min, and then heated from 20° C. to 350° C. at 10° C./min. The thermal properties were recorded on the second heating scan.
   The value of T_{g} was taken as the extrapolated onset temperature of the glass transition observed on the DSC scan (heat flow (W/g) against temperature (° C.)), as described in ASTM E1356-98.
   The values of T_{cc} and Tₘ were taken from the DSC scan as the temperature at which peak heat flow was observed in the respective transitions.
   Herein, the degree of crystallinity was measured for samples which have been annealed at 200° C. for 2 hours, unless otherwise stated. The annealing of the sample was conducted during a DSC heating cycle according to the following test method and based on the method described in ASTM E1356-98, using a 5 mg sample and the equipment noted above. The full heating cycle for these crystallinity measurements was as follows:
      (i) Heated from 20 to 300° C. at 20° C./min
      (ii) Held at 300° C. for 5 minutes
      (iii) Cooled to 20° C. at 20° C./min
      (iv) Heated to 200° C. at 20° C./min
      (v) Held at 200° C. for 120 min
      (vi) Cooled to 20° C.
      (vii) Heated from 20 to 400° C. at 10° C./min.
   The thermal properties were recorded on the final heating scan.
   The degree of crystallinity (X_{c}) was calculated according to the equation:

X_{c}=ΔHₘ/ΔHₘ°
wherein:
ΔHₘ=experimental enthalpy of fusion calculated from the integral of the melting endotherm;
ΔHₘ°=theoretical enthalpy of fusion of the corresponding poly(alkylene-carboxylate) homopolymer (i.e. without the co-monomer of formula (I)) at 100% crystallinity. Thus, for copolyesters of the present invention comprising repeating units derived from ethylene glycol, naphthalene-dicarboxylic acid and the co-monomer of formula (I), ΔHₘ° is the theoretical enthalpy of fusion of a 100% crystalline PEN polymer (103 J/g), and for copolyesters of the present invention comprising repeating units derived from ethylene glycol, terephthalic acid and the co-monomer of formula (I), ΔHₘ° is the theoretical enthalpy of fusion of a 100% crystalline PET polymer (140 J/g), as defined in the literature (B. Wunderlich, Macromolecular Physics, Academic Press, New York, (1976)).
(ii) Inherent viscosity (ηᵢₙₕ) was determined at 25° C. for 0.1% w/v solutions of the polymer in CHCl₃/TFA (2:1) using a Schott-Geräte CT-52 auto-viscometer, with capillary No. 53103. Inherent viscosities were calculated as:

ηᵢₙₕ=ln[(t₂/t₁)/c]
wherein:
ηᵢₙₕ=Inherent Viscosity (dL/g)
t₁=Flow time of solvent (s)
t₂=Flow time of the polymer solution (s)
c=Concentration of the polymer (g/dL)
Preferably, the inherent viscosity of the copolyesters described herein is at least 0.7 dL/g. Such viscosities are readily obtainable using SSP techniques.
(iii) Carboxyl end-group content (gram equivalents/10⁶ g polymer) was determined by ¹H-NMR spectroscopy at 80° C. in d₂-TCE using an Eclipse+500 spectrometer.
(iv) Degree of crystallinity of the film was measured via measurement of density. The density of the film samples was measured using a calibrated calcium nitrate/water density column controlled at a constant 23° C. using a water jacket using the following method. Two 860 ml calcium nitrate solutions of known densities were prepared, filtered and degassed in vacuo for 2 h before being pumped simultaneously into a graduated column tube under hydrostatic equilibrium. The two calcium nitrate solutions of known density are low and high concentration solutions which form a range of densities within the column to encompass the expected densities for the semi-crystalline films of the present invention (corresponding to a degree of crystallinity of from about 0 to about 60%, as defined by the literature densities for the 0 and 100% homopolymers, as noted below for the PET and PEN homopolymers). The concentration of each solution is thus selected on the basis of the aromatic dicarboxylic acid in the polymer (or where more than one dicarboxylic acid is used, on the basis of the first aromatic dicarboxylic acid as defined herein), and the solutions used were as follows.
   PET: Low concentration solution: 1.28 g/cm³ (240.80 g calcium nitrate; 860 mL water; 1.71 M molar concentration with respect to calcium nitrate).
      High concentration solution: 1.43 g/cm³ (369.80 g calcium nitrate; 860 mL water; 2.62 M calcium nitrate).
   PEN: Low concentration solution: 1.32 g/cm³ (275.20 g calcium nitrate; 860 mL water; 1.95 M calcium nitrate).
      High concentration solution: 1.41 g/cm³ (352.60 g calcium nitrate, 860 mL water; 2.50 M calcium nitrate).
   The density column was calibrated using eight pips of known density which were washed in calcium nitrate solution before being placed in the graduated column. For each pip placed in the column, the volume height of the column was recorded upon reaching a constant level of suspension (after 4 to 5 hours). Separate measurements were taken for each pip to generate a calibration plot of volume height against density. The measurement method was repeated for each film specimen (dimensions 3×5 mm) and three specimens were used for each film sample to generate a mean of the measured volume height, from which the measured density (ρ_{recorded}) was obtained from the calibration plot. The degree of crystallinity (χ_{c}) was then calculated for each sample using Equation (1):

$${X}_{c} ( \% ) = 100 ( \frac{{ρ}_{recorded} - {ρ}_{amorphous}}{{ρ}_{crystalline} - {ρ}_{amorphous}} ) \qquad ( 1 )$$

where
χ_{c}=degree of crystallinity (%)
ρ_{recorded}=recorded density of polymer (g cm⁻³)
ρₐₘₒᵣₚₕₒᵤₛ=known density of amorphous homopolymer (o % crystallinity)
ρ_{crystalline}=known density of 100% crystalline homopolymer.

The invention is further illustrated by the following examples. It will be appreciated that the examples are for illustrative purposes only and are not intended to limit the invention as described above. Modification of detail may be made without departing from the scope of the invention.

### EXAMPLES

Reaction schemes to prepare copolyesters of the present invention are shown in Schemes 1 and 2 below.

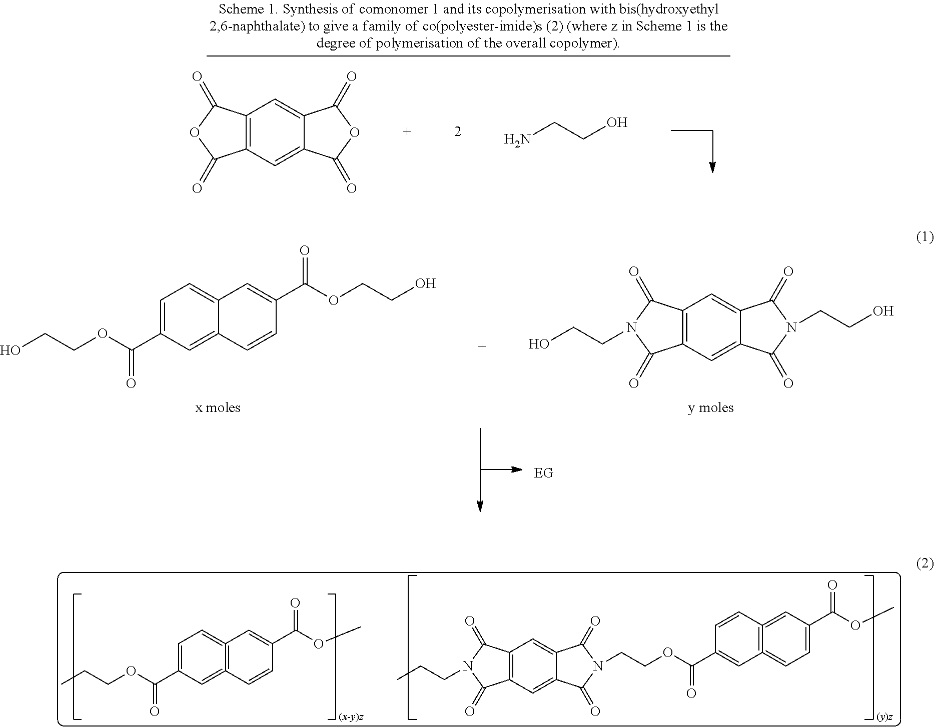

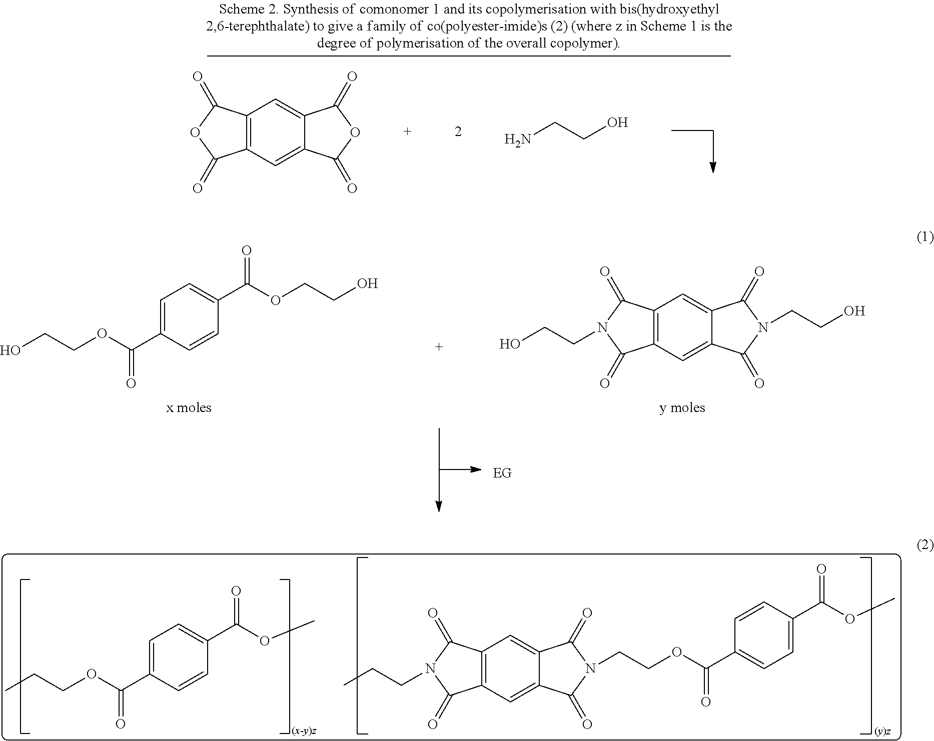

### Example 1

### Synthesis of (Monomer 1)

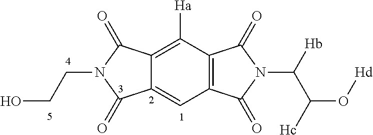

Ethanolamine (1.70 mL, 27.56 mmol) was added to a mixture of pyromellitic dianhydride (3.01 g, 13.80 mmol), DMAc (25 mL) and toluene (15 mL). The reaction mixture was then refluxed overnight, using a Dean-Stark apparatus to azeotropically distil off the co-produced water. The reaction mixture was cooled to room temperature and poured into water (˜400 mL) upon which a white precipitate formed. The suspension was stirred for 6 h, filtered, and the solid was washed with water and MeOH and dried under vacuum at 100° C. overnight to produce 3.72 g of N,N′-bis-(2-hydroxyethyl)-pyromellitic diimide as an off-white powder (yield: 89%; mp (DSC): 283° C.; MS m/z=327.0589 [M+Na], calculated 327.0545, ¹H NMR (400 MHz, DMSO) δ(ppm) 8.22 (4H, m, H_{b+c}), 7.97 (2H, d, J=8.16 Hz, Hₐ), 4.85 (2H, t, J=12.0 Hz, H_{f}), 3.67 (4H, t, J=11.3 Hz, H_{d}), 3.59 (4H, m, H_{f}); ¹³C NMR (100 MHz, DMSO) δ (ppm) 167.48 (C₇₊₈), 144.00 (C₁), 137.17 (C₃), 132.75 (C₄), 131.42 (C₆), 123.53 (C₂), 121.68 (C₅), 57.90 (C₉), 40.42 (C₁₀); IR (νₘₐₓ cm⁻¹) 3385, 3034, 2947, 2883, 1771, 1697, 1394, 1362, 1132).

### Examples 2 to 11

### Synthesis of the Copolyesters

Two series of novel linear poly(ester-imide)s were synthesised, by polycondensation between either bis-(2-hydroxyethyl)-terephthalate (BHET) or bis-(2-hydroxyethyl)-2,6-naphthalate (BHEN) and the comonomer of formula (I). Copolymers containing varying amounts of co-monomer were obtained using Sb₂O₃ or GeO₂ as catalyst. Transesterification was carried out under vacuum at 190-200° C. over ca. 30-90 minutes, followed by a polycondensation stage at 290-300° C. The polymers were soluble in TFA and/or HFIP, and in mixtures of either TFA or HFIP with CHCl₃. Re-precipitation in MeOH gave white or off-white polymer beads which were isolated by filtration, washed with methanol and dried.

The general polyesterification procedure, illustrated for PET, is as follows: bis(2-hydroxyethyl) terephthalate (BHET, 5.01 g, 19.71 mmol) and Sb₂O₃ (1.50 mg, 4.12×10⁻³ mmol) were charged to a Schlenk tube fitted with a rubber-sealed stirrer guide and a glass stirrer rod. The reaction mixture was heated to the trans-esterification temp (Temp 1) over 30 minutes by use of a tube furnace under an inert nitrogen atmosphere and held for 20-30 minutes. A stirring rate of 300 rpm was then applied via a mechanical stirrer and the reaction mixture heated to the polycondensation temperature (Temp 2) over 40 min. A vacuum between 0.1 and 1 torr was gradually applied over 1-2 minutes and the temperature was maintained for a period (Soak Time) until the stirring rate dropped to 250-260 rpm as a result of the increasing viscosity of the reaction mixture. At this point, nitrogen was purged through the system, the stirrer was removed and the mixture was allowed to cool. The reaction tube was cut and the lower section, containing the polymer, was broken up. The polymer was dissolved away from the tube fragments and from the stirrer-rod in a solution of CHCl₃/TFA (2:1) (˜50 mL), and the glass was filtered off. The resulting brown solution was concentrated in vacuo to ˜15 mL and beads were formed by precipitation in MeOH (˜120 mL). The polymer beads were filtered, washed with MeOH (2×15 mL) and dried in a vacuum oven overnight at 120° C. for PET (150° C. for PEN). The corresponding conditions for PEN are shown in Table 1 below.

TABLE 1

| | | | | Temp | Temp | Vac- | Soak |
|---|---|---|---|---|---|---|---|
| Monomer | Monomer | | Catalyst | 1 | 2 | uum | Time |
| (g) | Mass (mg) | Catalyst | Mass (mg) | (° C.) | (° C.) | (torr) | (min) |
| BHET | 5.01 | Sb₂O₃ | 1.5 | 190 | 290 | 0.4 | 60 |
| BHEN | 5.00 | GeO₂ | 5.1 | 200 | 300 | 0.8 | 110 |

Replacement of varying amounts of BHET by comonomer (I), as shown in Table 2 below, provided copolyesters of PET with varying mole fractions of comonomer (I).

TABLE 2

| | | | | | Temp | | | Soak |
|---|---|---|---|---|---|---|---|---|
| | mol | BHET | PDI | Sb₂O₃ | 1 | Temp 2 | Vacuum | Time |
| Ex. | (%) | (g) | (g) | (mg) | (° C.) | (° C.) | (torr) | (min) |
| 2 | 5 | 4.7518 | 0.2996 | 1.6 | 190 | 290 | 0.6 | 50 |
| 3 | 10 | 4.5006 | 0.5994 | 1.7 | 190 | 300 | 0.7 | 45 |
| 4 | 15 | 4.2503 | 0.8981 | 1.6 | 190 | 290 | 0.6 | 45 |
| 5 | 20 | 2.4003 | 0.7187 | 1.0 | 190 | 290 | 0.7 | 30 |
| 6 | 25 | 2.2508 | 0.8979 | 1.0 | 190 | 290-310 | 0.5 | 30 |

The analytical results for the PET copolyesters are as follows.

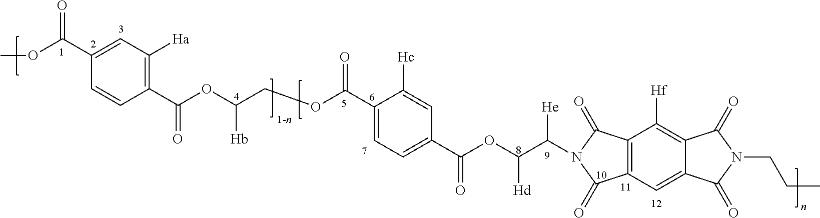

### Example 2

### PETcoPDI-5

¹H NMR (400 MHz, CDCl₃:TFA (2:1)) δ (ppm) 8.40 (s, H_{f}), 8.17 (s, Hₐ), 8.10 (s, Hₑ), 4.84 (s, H_{b}), 4.70 (s, H_{d}), 4.29 (s, Hₑ), ¹³C NMR (100 MHz, CDCl₃:TFA (2:1)) 167.85 (C₁), 166.98 (C₁₀), 137.09 (C₁₁), 133.31 (C₂), 133.11 (C₆), 130.05 (C₃), 119.33 (C₁₂), 63.92 (C₄), 63.50 (C₈), 37.67 (C₉), Tg=88° C., Tcc=170° C., Tm=243° C., Tc=156° C., ηᵢₙₕ=0.58 dL g⁻¹.

### Example 3

### PETcoPDI-10

¹H NMR (400 MHz, CDCl₃:TFA (2:1)) δ (ppm) 8.40 (s, 2H_{f}), 8.17 (s, 2Hₐ), 8.09 (m, 2H_{c}), 4.84 (s, 4H_{b}), 4.70 (s, 4H_{d}), 4.29 (s, 4Hₑ), ¹³C NMR (100 MHz, CDCl₃:TFA (2:1)) 167.84 (C₁), 166.91 (C₁₀), 137.09 (C₁₁), 133.32 (C₂), 133.12 (C₆), 130.05 (C₃), 119.33 (C₁₂), 63.92 (C₄), 63.49 (C₈), 37.66 (C₉), Tg=96° C., Tcc=158° C., Tm=232° C., Tc=159° C., ηᵢₙₕ=0.69 dL g⁻¹.

### Example 4

### PETcoPDI-15

¹H NMR (400 MHz, CDCl₃:TFA (2:1)) δ (ppm) 8.40 (s, 2H_{f}), 8.17 (s, 2Hₐ), 8.08 (m, 2H_{c}), 4.83 (s, 4H_{b}), 4.70 (s, 4H_{d}), 4.29 (s, 4Hₑ), ¹³C NMR (100 MHz, CDCl₃:TFA (2:1)) 167.80 (C₁), 166.93 (C₁₀), 137.08 (C₁₁), 133.31 (C₂), 133.10 (C₆), 130.04 (C₃), 119.33 (C₁₂), 63.92 (C₄), 63.51 (C₈), 37.65 (C₉), Tg=106° C., Tcc=171° C., Tm=247° C., Tc=176° C., ηᵢₙₕ=1.02 dL g⁻¹.

### Example 5

### PETcoPDI-20

¹H NMR (400 MHz, CDCl₃:TFA (2:1)) δ (ppm) 8.39 (s, 2H_{f}), 8.17 (s, 2Hₐ), 8.08 (d, 2H_{c}), 4.83 (s, 4H_{b}), 4.70 (s, 4H_{d}), 4.29 (s, 4Hₑ), ¹³C NMR (100 MHz, CDCl₃:TFA (2:1)) 167.85 (C₁), 166.93 (C₁₀), 137.08 (C₁₁), 133.30 (C₂), 133.09 (C₆), 130.04 (C₃), 119.34 (C₁₂), 63.92 (C₄), 63.51 (C₈), 37.64 (C₉), Tg=102° C., ηᵢₙₕ=0.45 dL g⁻¹.

### Example 6

### PETcoPDI-25

¹H NMR (400 MHz, CDCl₃:TFA (2:1)) δ (ppm) 8.39 (s, 2H_{f}), 8.17 (s, 2Hₐ), 8.08 (d, 2H_{c}), 4.84 (s, 4H_{b}), 4.70 (s, 4H_{d}), 4.29 (s, 4Hₑ), ¹³C NMR (100 MHz, CDCl₃:TFA (2:1)) 167.69 (C₁), 166.87 (C₁₀), 137.10 (C₁₁), 133.35 (C₂), 133.14 (C₆), 130.04 (C₃), 119.28 (C₁₂), 63.89 (C₄), 63.47 (C₈), 37.67 (C₉), Tg=97° C., ηᵢₙₕ=0.30 dL g⁻¹, IR (νₘₐₓ cm⁻¹) 2956, 1717, 1457, 1405, 1388, 1340, 1263, 1251, 1119, 1102.

Replacement of varying amounts of BHEN by comonomer (I), as shown in Table 3 below, provided copolyesters of PEN with varying mole fractions of comonomer (I).

TABLE 3

| | | | | | | | | Soak |
|---|---|---|---|---|---|---|---|---|
| | Mol | BHEN | PDI | GeO₂ | Temp 1 | Temp 2 | Vacuum | Time |
| Ex. | (%) | (g) | (g) | (mg) | (° C.) | (° C.) | (torr) | (min) |
| 7 | 5 | 4.7506 | 0.2995 | 4.9 | 200 | 300 | 2.0 | 90 |
| 8 | 10 | 4.5009 | 0.5000 | 4.8 | 200 | 300 | 1.2 | 90 |
| 9 | 15 | 4.2503 | 0.8981 | 4.8 | 200 | 300 | 2.3 | 90 |
| 10 | 20 | 3.9998 | 1.0003 | 4.7 | 200 | 300 | 1.6 | 90 |
| 11 | 25 | 3.7502 | 1.2498 | 4.9 | 200 | 300 | 2.1 | 80 |

The analytical results for the PET copolyesters are as follows.

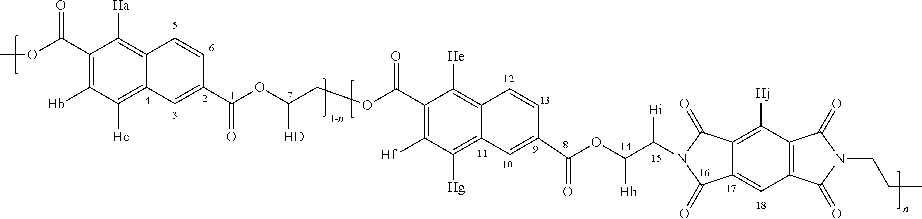

### Example 7

### PENcoPDI-5

¹H NMR (500 MHz, CDCl₃:TFA (2:1)) δ (ppm) 8.70 (s, Hₐ), 8.62 (s, Hₑ), 8.40 (s, Hⱼ), 8.14 (d, J=8.5 Hz, H_{b}), 8.06 (d, J=8.5 Hz, H_{c}), 8.02 (m, H_{g}), 7.94 (s, H_{f}), 4.92 (s, H_{d}), 4.74 (s, Hₕ), 4.32 (s, Hᵢ), ¹³C NMR (125 MHz, CDCl₃:TFA (2:1)) 168.87 (C₁), 166.98 (C₁₆), 137.14 (C₁₇), 135.01 (C₄), 134.87 (C₁₁), 131.59 (C₃), 130.25 (C₅), 128.46 (C₂), 128.17 (C₉), 125.84 (C₆), 125.70 (C₁₃), 119.36 (C₁₈), 64.00 (C₇), 63.47 (C₈), 37.78 (C₉), Tg=130° C., Tm=256° C., ηᵢₙₕ=0.49 dL g⁻¹.

### Example 8

### PENcoPDI-10

¹H NMR (400 MHz, CDCl₃:TFA (2:1)) δ (ppm) 8.71 (s, 2Hₐ), 8.60 (m, 2Hₑ), 8.40 (s, 2Hⱼ), 8.13 (d, J=8.4 Hz, 2H_{b}), 8.05 (d, J=8.8 Hz, 2H_{c}), 8.02 (s, 2H_{f}, 2H_{g}), 4.91 (s, 4H_{d}), 4.74 (s, 4Hₕ), 4.32 (s, 4Hᵢ), ¹³C NMR (100 MHz, CDCl₃:TFA (2:1)) 168.89 (C₁), 166.98 (C₁₆), 137.10 (C₁₇), 134.98 (C₄), 131.58 (C₃), 130.23 (C₅₊₁₂), 128.40 (C₂), 128.14 (C₉), 125.79 (C₆), 125.68 (C₁₃), 119.36 (C₁₈), 64.00 (C₇), 63.45 (C₈), 37.74 (C₉), Tg=136° C., ηᵢₙₕ=0.52 dL g⁻¹.

### Example 9

### PENcoPDI-15

¹H NMR (400 MHz, CDCl₃:TFA (2:1)) δ (ppm) 8.71 (m, 2Hₐ), 8.60 (m, 2Hₑ), 8.40 (s, 2Hⱼ), 8.14 (d, J=8.4 Hz, 2H_{b}), 8.03 (m, 2H_{c}, 2H_{f}, 2H_{g}), 4.91 (s, 4H_{d}), 4.74 (s, 4Hₕ), 4.32 (s, 4Hᵢ), ¹³C NMR (100 MHz, CDCl₃:TFA (2:1)) 168.91 (C₁), 166.99 (C₁₆), 137.10 (C₁₇), 134.98 (C₄), 131.58 (C₃), 130.22 (C₅), 128.39 (C₂), 128.10 (C₉), 125.78 (C₆), 125.64 (C₁₃), 119.37 (C₁₈), 63.98 (C₇), 63.45 (C₈), 37.76 (C₉), Tg=144° C., ηᵢₙₕ=0.47 dL g⁻¹.

### Example 10

### PENcoPDI-20

¹H NMR (400 MHz, CDCl₃:TFA (2:1)) δ (ppm) 8.71 (m, 2Hₐ), 8.60 (m, 2Hₑ), 8.40 (s, 2Hⱼ), 8.14 (d, J=8.8 Hz, 2H_{b}), 8.03 (m, 2H_{c}, 2H_{f}, 2H_{g}), 4.91 (s, 4H_{d}), 4.74 (s, 4Hₕ), 4.32 (s, 4Hᵢ), ¹³C NMR (100 MHz, CDCl₃:TFA (2:1)) 168.90 (C₁), 166.98 (C₁₆), 137.11 (C₁₇), 134.98 (C₄), 131.58 (C₃), 130.23 (C₅), 128.40 (C₂), 128.12 (C₉), 125.79 (C₆), 125.65 (C₁₃), 119.45 (C₁₈), 63.99 (C₇), 63.45 (C₈), 37.82 (C₉), Tg=148° C., ηᵢₙₕ=0.46 dL g⁻¹.

### Example 11

### PENcoPDI-25

¹H NMR (500 MHz, CDCl₃:TFA (2:1)) δ (ppm) 8.73 (m, 2Hₐ), 8.62 (m, 2Hₑ), 8.42 (s, 2Hⱼ), 8.16 (d, J=10.45 Hz, 2H_{b}), 8.06 (m, 2H_{c}, 2H_{f}, 2H_{g}), 4.95 (s, 4H_{d}), 4.76 (s, 4Hₕ), 4.34 (s, 4Hᵢ), ¹³C NMR (500 MHz, CDCl₃:TFA (2:1)) 168.81 (C₁), 166.98 (C₁₆), 137.11 (C₁₇), 134.98 (C₄), 134.94 (C₁₁), 131.59 (C₃), 131.55 (C₁₀), 130.24 (C₅₊₁₂), 128.43 (C₂), 128.14 (C₉), 125.83 (C₆), 125.68 (C₁₃), 119.35 (C₁₈), 64.00 (C₇), 63.48 (C₈), 37.76 (C₉), Tg=151° C., ηᵢₙₕ=0.45 dL g⁻¹, IR (νₘₐₓ cm⁻¹) 2956, 1717, 1387, 1339, 1278, 1257, 1182, 1132, 1091.

The experimental data for the Examples are summarized in Table 4 below. The control samples are pure PET or PEN, synthesised in accordance with the procedure described for Examples 2 to 11, but without the inclusion of the comonomer. The enthalpy of fusion and degree of crystallinity data in Table 4 were obtained using the standard (non-annealing) DSC process.

TABLE 4

| Exam- | | T_{g} | T_{cc} | Tₘ | ΔHₘ | Xc | Viscosity |
|---|---|---|---|---|---|---|---|
| ple | Polymer | (° C.) | (° C.) | (° C.) | (J/g) | (%) | (gdL⁻¹) |
| Control | PET | 75 | — | 257 | 44 | 31 | 0.80 |
| 2 | PETcoPDI-5 | 88 | 170 | 243 | 23 | 16 | 0.58 |
| 3 | PETcoPDI-10 | 96 | 158 | 232 | 13 | — | 0.69 |
| 4 | PETcoPDI-15 | 106 | 171 | 247 | 4 | — | 1.02 |
| 5 | PETcoPDI-20 | 102 | — | 245 | 2 | — | 0.45 |
| 6 | PETcoPDI-25 | 97 | — | — | — | — | 0.3 |
| Control | PEN | 119 | 191 | 267 | 36 | 35 | 0.67 |
| 7 | PENcoPDI-5 | 130 | 224 | 256 | 4.9 | 5 | 0.49 |
| 8 | PENcoPDI-10 | 136 | — | — | — | — | 0.52 |
| 9 | PENcoPDI-15 | 144 | — | — | — | — | 0.47 |
| 10 | PENcoPDI-20 | 148 | — | — | — | — | 0.46 |
| 11 | PENcoPDI-25 | 151 | — | — | — | — | 0.45 |

### Examples 12, 13 and 14

Three PEN copolymers (referred to herein as PENcoPDI-5, PENcoPDI-10 and PENcoPDI-16) comprising 5, 10.3 and 16.4 mol %, respectively, of monomer (I) were manufactured on a larger scale (using a 5 gallon reactor) using the synthetic methods described above, then dried overnight (8 hours at 150° C.), and biaxially oriented films manufactured therefrom. The amount of comonomer (I) in the copolymer was determined by NMR. A 100% PEN film was also prepared as a control.

Each polymer was fed to an extruder (single screw; screw speed approx. 80 rpm) at a temperature in the range of 275 to 300° C. A cast film was produced, which was electrostatically pinned and threaded around the casting drum and over the top of the forward draw onto a scrap winder. Once settled, cast samples are collected at a range of casting drum speeds (2, 3 and 5 m\min) to give a range of thicknesses. The cast films are subsequently drawn using a Long Stretcher (supplied by T.M. Long Co., Somerville, N.J.). The Long Stretcher comprises a hydraulically operated stretching head mounted inside a heated oven with a liftable lid. The operation of the stretching mechanism is based upon the relative motion of two pairs of draw bars (one fixed and one moveable, mounted normally to one another). The draw bars are attached to hydraulic rams which control the amount (draw ratio) and speed (draw rate) of the imposed stretching. On each draw bar are mounted pneumatic sample clips attached to a pantograph system. A sample loading system is used to position samples within the pneumatic clips. A cast sample cut to a specific size (11.1×11.1 cm) is located symmetrically on a vacuum plate attached to the end of an arm. The arm is run into the oven and the sample lowered so that it is between the clips. The clips are closed using nitrogen pressure to hold the film and the loading arm withdrawn. The oven is heated to a specified temperature by two plate-heaters. The lid is lowered and air heaters rapidly bring the sample up to a specified temperature. After a suitable preheat time (30 seconds), the draw is manually initiated by the operator. A draw rate of approximately 2.54 cm/second was used. Simultaneous biaxial draw in perpendicular directions is used in these examples. The processing conditions are given in Table 5 below.

TABLE 5

| | Approx | Air Heater | Plate Heater |
|---|---|---|---|
| Sample ID | Draw Ratio | Temp (° C.) | Temp (° C.) |
| Control: 100% PEN | 3.5 × 3.5 | 155 | 150 |
| Ex. 12: PENcoPDI-5 | 3.5 × 3.5 | 155 | 150 |
| Ex. 13: PENcoPDI-10 | 3.5 × 3.5 | 168 | 160 |
| Ex. 14: PENcoPDI-16 | 3.5 × 3.5 | 165 | 160 |

The films produced on the Long Stretcher are then crystallised using the Laboratory Crystallisation Rig and held at specified temperatures for specified times (as presented in Tables 6 to 9 below). In this equipment, samples are clamped in a frame which is dropped pneumatically and held between heated platens for a specific time before being rapidly quenched by dropping into iced water.

Crystallinity of film samples was calculated using the density method described herein on the basis of the following literature data for known values for PEN density and crystallinity:

Density of 0% crystallinity PEN=1.325 g/cm³

Density of 100% crystallinity PEN=1.407 g/cm³

The density and crystallinity results for the films are shown in Tables 6 to 9 below.

TABLE 6
PEN control film

| Sample | Crystallisation conditions | Density | % Crystallinity |
|---|---|---|---|
| 1 | None | 1.346 | 25.88 |
| 2 | 2 s @ 220° C. | 1.360 | 42.67 |
| 3 | 10 s @ 220° C. | 1.361 | 43.82 |
| 4 | 100 s @ 220° C. | 1.362 | 45.35 |
| 5 | 2 s @ 230° C. | 1.363 | 45.74 |
| 6 | 10 s @ 230° C. | 1.362 | 45.60 |
| 7 | 100 s @ 230° C. | 1.366 | 49.37 |
| 8 | 2 s @ 240° C. | 1.362 | 44.82 |
| 9 | 10 s @ 240° C. | 1.362 | 45.21 |
| 10 | 100 s @ 240° C. | 1.361 | 43.32 |

TABLE 7
PENcoPDI-5 film (Example 12)

| Sample | Crystallisation conditions | Density | % Crystallinity |
|---|---|---|---|
| 1 | None | 1.3537 | 35.03 |
| 2 | 2 s @ 200° C. | 1.3516 | 32.49 |
| 3 | 10 s @ 200° C. | 1.3624 | 45.57 |
| 4 | 100 s @ 200° C. | 1.3639 | 47.47 |
| 5 | 2 s @ 210° C. | 1.3627 | 45.96 |
| 6 | 10 s @ 210° C. | 1.3635 | 46.94 |
| 7 | 100 s @ 210° C. | 1.3631 | 46.41 |
| 8 | 2 s @ 220° C. | 1.3613 | 44.21 |
| 9 | 10 s @ 220° C. | 1.3622 | 45.38 |
| 10 | 100 s @ 220° C. | 1.3641 | 47.66 |
| 11 | 2 s @ 225° C. | 1.3613 | 44.31 |
| 12 | 10 s @ 225° C. | 1.3622 | 45.33 |
| 13 | 100 s @ 225° C. | 1.3643 | 47.96 |
| 14 | 2 s @ 230° C. | 1.3559 | 37.74 |
| 15 | 10 s @ 230° C. | 1.3629 | 46.24 |
| 16 | 100 s @ 230° C. | 1.3627 | 45.92 |
| 17 | 2 s @ 240° C. | 1.3581 | 40.42 |

TABLE 8
PENcoPDI-10 film (Example 13)

| Sample | Crystallisation Conditions | Density (g\cm3) | % Crystallinity |
|---|---|---|---|
| 1 | None | 1.3637 | 47.17 |
| 2 | 2 s @ 180° C. | 1.3577 | 39 |
| 3 | 10 s @ 180° C. | 1.3608 | 43.71 |
| 4 | 100 s @ 180° C. | 1.3672 | 51.41 |
| 5 | 10 s @ 190° C. | 1.3592 | 41.69 |
| 6 | 10 s @ 200° C. | 1.3637 | 47.15 |

TABLE 9
PENcoPDI-16 film (Example 14)

| Sample | Crystallisation Conditions | Density (g\cm3) | % Crystallinity |
|---|---|---|---|
| 1 | None | 1.3590 | 41.5 |
| 2 | 10 s @ 180° C. | 1.3594 | 41.97 |
| 3 | 10 s @ 190° C. | 1.3625 | 45.71 |

The data in Tables 7, 8 and 9 demonstrate that the copolymers of the present invention can be manufactured into crystalline biaxially oriented films under typical stenter conditions used on a conventional film-line, and that films manufactured in this way exhibit excellent crystallinity. With the higher amounts of comonomer present in Examples 13 and 14, the manufacture of biaxially oriented crystalline films is suitably conducted at relatively lower heat-set (crystallisation) temperatures in the stenter.

### Examples 15 and 16

Two PET copolymers (referred to herein as PETcoPDI-12 and PETcoPDI-16) comprising 12.5 and 16.7 mol %, respectively, of monomer (I) were manufactured on a larger scale (using a 5 gallon reactor) using the synthetic methods described above for Example 12. The amount of comonomer (I) in the copolymer was determined by NMR. The copolymer PETcoPDI-12 exhibited a Tg of 108° C. and a Tm of 240° C. The copolymer PETcoPDI-16 exhibited a Tg of 103° C. and a Tm of 257° C. The polymers were dried overnight as described above and biaxially oriented films manufactured therefrom as described above. A 100% PET film was also prepared as a control. The processing conditions are given in Table 10 below.

TABLE 10

| | | | Plate | | |
|---|---|---|---|---|---|
| | | Air Heater | Heater | | Preheat |
| | Draw | Temp | Temp | Draw Speed | Time |
| Sample | Ratio | (° C.) | (° C.) | (cm\sec) | (sec) |
| Control: | 3.5 × 3.5 | 100 | 100 | 2.54 | 30 |
| 100% PET | | | | | |
| Ex. 15: | 3.5 × 3.5 | 120 | 120 | 5.08 | 30 |
| PETcoPDI-12 | | | | | |
| Ex. 16: | 3.5 × 3.5 | 110 | 108 | 5.08 | 25 |
| PETcoPDI-16 | | | | | |

Crystallinity of film samples was calculated using the density method described herein on the basis of the following literature data for known values for PET density and crystallinity:

Density of 0% crystallinity PET=1.335 g/cm³

Density of 100% crystallinity PET=1.455 g/cm³

The density and crystallinity results for the films are shown in Tables 11, 12 and 13 below.

TABLE 11
100% PET Control Film

| Sample | Crystallisation Conditions | Density (g\cm3) | % Crystallinity |
|---|---|---|---|
| 1 | None | 1.3529 | 14.94 |
| 2 | 2 s @ 220° C. | 1.3944 | 49.48 |
| 3 | 10 s @ 220° C. | 1.3969 | 51.57 |
| 4 | 100 s @ 220° C. | 1.3913 | 46.93 |
| 5 | 2 s @ 230° C. | 1.3903 | 46.06 |
| 6 | 10 s @ 230° C. | 1.3888 | 44.85 |
| 7 | 100 s @ 230° C. | 1.3910 | 46.66 |
| 8 | 2 s @ 240° C. | 1.3597 | 20.59 |
| 9 | 10 s @ 240° C. | 1.3959 | 50.74 |
| 10 | 100 s @ 240° C. | Melted | Melted |

The PET control film exhibited a crystallinity of 14.94% for the non-heat-set biaxially oriented film, and this increased to about 50% after additional crystallisation during heat-setting. At 240° C. the film samples started to melt during crystallisation.

TABLE 12
PETcoPDI-12 Film (Example 15)

| Sample | Crystallisation Conditions | Density (g\cm³) | % Crystallinity |
|---|---|---|---|
| 1 | None | 1.3669 | 26.60 |
| 2 | 2 s @ 220° C. | 1.3735 | 32.08 |
| 3 | 10 s @ 220° C. | 1.3716 | 30.54 |
| 4 | 100 s @ 220° C. | 1.3743 | 32.79 |
| 5 | 2 s @ 230° C. | 1.3717 | 30.55 |
| 6 | 10 s @ 230° C. | 1.3713 | 30.23 |
| 7 | 100 s @ 230° C. | 1.3717 | 30.55 |
| 8 | 2 s @ 240° C. | Melted | Melted |
| 9 | 10 s @ 240° C. | Melted | Melted |
| 10 | 100 s @ 240° C. | Melted | Melted |

TABLE 13
PETcoPDI-16 Film (Example 16)

| Sample | Crystallisation Conditions | Density (g\cm³) | % Crystallinity |
|---|---|---|---|
| 1 | None | 1.3681 | 27.62 |
| 2 | 2 s @ 220° C. | 1.3890 | 45.01 |
| 3 | 10 s @ 220° C. | 1.3884 | 44.47 |
| 4 | 100 s @ 220° C. | 1.3871 | 43.45 |
| 5 | 2 s @ 230° C. | 1.3901 | 45.94 |
| 6 | 10 s @ 230° C. | 1.3875 | 43.75 |
| 7 | 100 s @ 230° C. | 1.3922 | 47.70 |
| 8 | 2 s @ 240° C. | 1.3903 | 46.09 |
| 9 | 10 s @ 240° C. | 1.3832 | 40.10 |
| 10 | 100 s @ 240° C. | 1.3898 | 45.65 |

The data in Tables 12 and 13 demonstrate that the copolymers of the present invention can be manufactured into crystalline biaxially oriented films under typical stenter conditions used on a conventional film-line, and that films manufactured in this way exhibit excellent crystallinity. Because of the lower melting point of Example 15, the manufacture of biaxially oriented crystalline films is suitably conducted at relatively lower heat-set (crystallisation) temperatures in the stenter.

### Example 17

The PENcoPDI-5 copolyesterimide was manufacture using solid state polymerisation techniques, using a starting polymer prepared in a manner similar to that described for Example 7 above. A polymer sample weighing approximately 5 g was placed in a Schlenk tube within a hot block. The sample was then heated at 200° C. for 16 h in vacuo (<0.1 mbar). After the SSP procedure, the higher molecular weight polymer was analysed by DSC to measure the crystallinity of the polymer directly after SSP (i.e. without erasing its thermal history), which demonstrated that the final polymer exhibited a ΔHₘ of 46.56 J g⁻¹ and a crystallinity of 45%.

The carboxyl end-group contents of the polymer were also analysed, and the values are presented in Table 14 below. As noted herein, the copolyesters described herein exhibit a surprisingly low carboxyl end-group content, and SSP accentuates this characteristic.

TABLE 14
Carboxyl end-group content

COOH end groups (gram
equivalents/10⁶g polymer)

| Sample | Pre-SSP | Post-SSP |
|---|---|---|
| PEN control | 22.96 | 13.12 |
| PENcoPDI5 | 3.83 | Not detected |

1. A semi-crystalline polyester film comprising a thermoplastic copolyester which comprises repeating units derived from an aliphatic glycol, an aromatic dicarboxylic acid, and the monomer of formula (I): 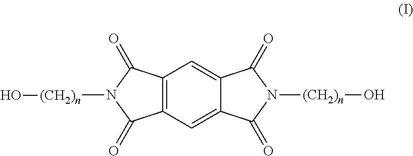
wherein n=2, 3 or 4, and wherein comonomer (I) constitutes a proportion of the glycol fraction of the copolyester.

2. The film according to claim 1 wherein the monomer (I) is present in a range of from about 1 to about 50 mol % of the glycol fraction of the copolyester.

3. The film according to claim 1 wherein the aliphatic glycol is selected from C₂, C₃ or C₄ aliphatic diols.

4. The film according to claim 1 wherein the aliphatic glycol is ethylene glycol.

5. The film according to claim 1 wherein the number of carbon atoms in the aliphatic glycol is the same as the number (n) in comonomer (I).

6. The film according to claim 1 wherein n=2.

7. The film according to claim 1 wherein the aromatic dicarboxylic acid is selected from naphthalene dicarboxylic acid and terephthalic acid.

8. The film according to claim 1 wherein the aromatic dicarboxylic acid is 2,6-naphthalene dicarboxylic acid.

9. The film according to claim 1 wherein the copolyester has formula (IIa): 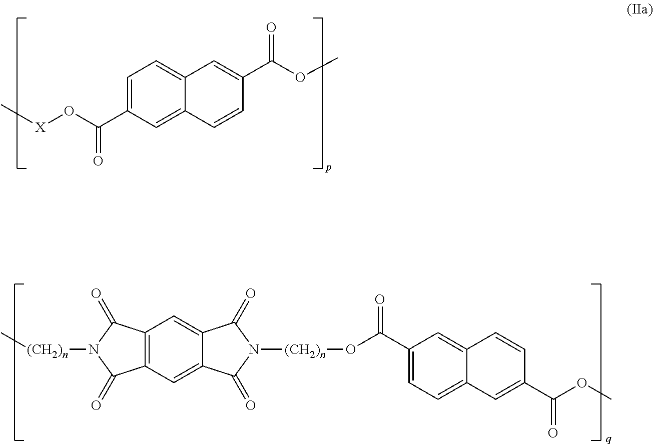
wherein:
n=2, 3 or 4;
the group X is the carbon chain of said aliphatic glycol; and
p and q are the molar fractions of the aliphatic glycol-containing repeating ester units and the monomer (I)-containing repeating ester units, respectively.

10. The film according to claim 9 wherein the monomer (I) is present in amounts of from about 3 to about 15 mol % of the glycol fraction of the copolyester.

11. The film according to claim 1 wherein the copolyester has formula (IIb): 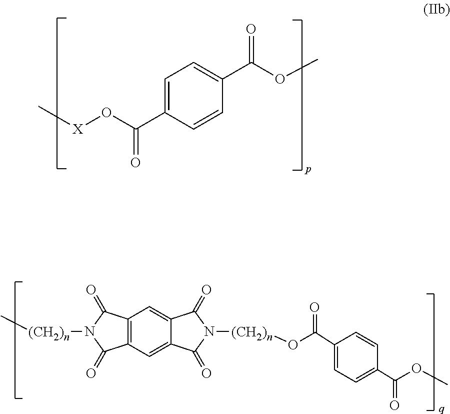
wherein:
n=2, 3 or 4;
the group X is the carbon chain of said aliphatic glycol; and
p and q are the molar fractions of the aliphatic glycol-containing repeating ester units and the monomer (I)-containing repeating ester units, respectively.

12. The film according to claim 11 wherein the monomer (I) is present in a range of from about 1 to about 30 mol % of the glycol fraction of the copolyester.

13. The film according to claim 1 wherein the copolyester exhibits a carboxyl end-group content of no more than 25 gram equivalents/10⁶ g polymer.

14. The film according to claim 1 wherein the film is an oriented film.

15. The film according to claim 1 wherein said aromatic dicarboxylic acid is naphthalene dicarboxylic acid and the degree of crystallinity of the film is at least about 10% as calculated from the film density and on the basis of the density of 0% crystalline polyethylene naphthalate (PEN) being 1.325 g/cm³ and the density of 100% crystalline PEN being 1.407 g/cm³; or wherein said aromatic dicarboxylic acid is terephthalic acid and the degree of crystallinity of the film is at least about 10% as calculated from the film density and on the basis of the density of 0% crystalline polyethylene terephthalate (PET) being 1.335 g/cm³ and the density of 100% crystalline PET being 1.455 g/cm³.

16. A process for preparing a thermoplastic copolyester comprising repeating units derived from an aliphatic glycol, an aromatic dicarboxylic acid, and the monomer of formula (I): 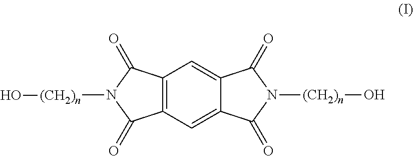
wherein n=2, 3 or 4, wherein comonomer (I) constitutes a proportion of the glycol fraction of the copolyester, wherein said process comprises the steps of:
(i) reacting said aliphatic glycol with said aromatic dicarboxylic acid to form a bis(hydroxyalkyl)-ester of said aromatic dicarboxylic acid; and
(ii) reacting said bis(hydroxyalkyl)-ester of said aromatic dicarboxylic acid with the monomer (I) under conditions of elevated temperature and pressure in the presence of a catalyst.

17. The process according to claim 16 wherein said aromatic dicarboxylic acid is naphthalene dicarboxylic acid and said bis(hydroxyalkyl)-ester is bis(hydroxyalkyl)-naphthalate, or wherein said aromatic dicarboxylic acid is terephthalic acid and said bis(hydroxyalkyl)-ester is bis(hydroxyalkyl)-terephthalate).

18. A thermoplastic copolyester comprising repeating units derived from an aliphatic glycol, an aromatic dicarboxylic acid, and the monomer of formula (I): 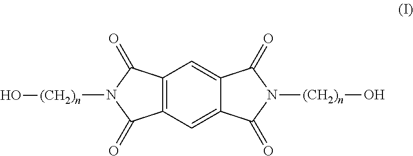
wherein n=2, 3 or 4;
wherein comonomer (I) constitutes a proportion of the glycol fraction of the copolyester; and
wherein said copolyester is obtainable by the process according to claim 16 and/or exhibits a carboxyl end-group content of no more than 25 gram equivalents/10⁶ g polymer.

19. The copolyester according to claim 18 wherein the monomer (I) is present in a range of from about 1 to about 50 mol % of the glycol fraction of the copolyester.

20. The copolyester according to claim 18 wherein the aliphatic glycol is selected from C₂, C₃ or C₄ aliphatic diols.

21. The copolyester according to claim 18 wherein the aliphatic glycol is ethylene glycol.

22. The copolyester according to claim 18 wherein the number of carbon atoms in the aliphatic glycol is the same as the number (n) in comonomer (I).

23. The copolyester according to claim 18 wherein n=2.

24. The copolyester according to claim 18 wherein the aromatic dicarboxylic acid is selected from naphthalene dicarboxylic acid and terephthalic acid.

25. The copolyester according to claim 18 wherein the aromatic dicarboxylic acid is 2,6-naphthalene dicarboxylic acid.

26. The copolyester according to claim 18 wherein the copolyester has formula (IIa): 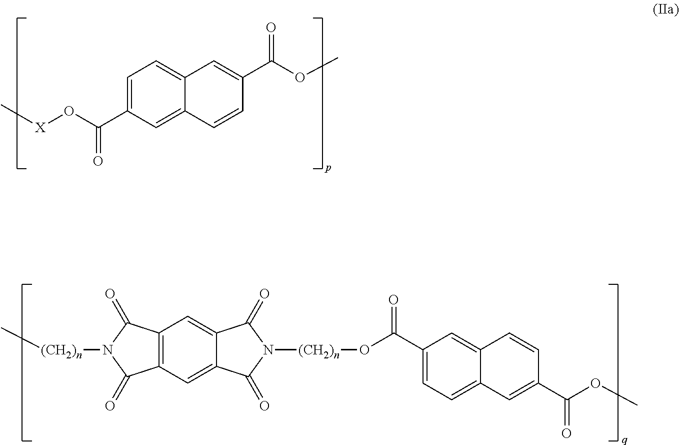
wherein:
n=2, 3 or 4;
the group X is the carbon chain of said aliphatic glycol; and
p and q are the molar fractions of the aliphatic glycol-containing repeating ester units and the monomer (I)-containing repeating ester units, respectively.

27. The copolyester according to claim 26 wherein the monomer (I) is present in amounts of from about 3 to about 15 mol % of the glycol fraction of the copolyester.

28. The copolyester according to claim 18 wherein the copolyester has formula (IIb): 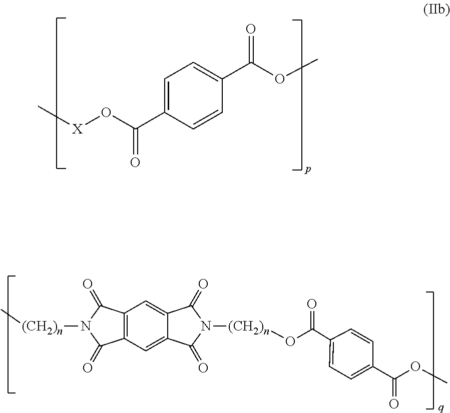
wherein:
n=2, 3 or 4;
the group X is the carbon chain of said aliphatic glycol; and
p and q are the molar fractions of the aliphatic glycol-containing repeating ester units and the monomer (I)-containing repeating ester units, respectively.

29. The copolyester according to claim 28 wherein the monomer (I) is present in a range of from about 1 to about 30 mol % of the glycol fraction of the copolyester.

30. The copolyester according to claim 18 wherein the copolyester exhibits a carboxyl end-group content of no more than 25 gram equivalents/10⁶ g polymer.

31. The film according to claim 1 wherein the copolyester contains only aliphatic glycol, an aromatic dicarboxylic acid and the monomer of formula (I).

32. The copolyester according to claim 18 wherein the copolyester contains only aliphatic glycol, an aromatic dicarboxylic acid and the monomer of formula (I).
